(19) United States
(12) Patent Application Publication
(10) Pub. No.: US 2013/0051956 A1
(43) Pub. Date: Feb. 28, 2013

(54) IRRIGATION MACHINE TRUSS SYSTEM CONNECTOR ASSEMBLY

(71) Applicant: Lindsay Corporation, Omaha, NE (US)

(72) Inventor: Julie Schornack, Columbus, NE (US)

(73) Assignee: Lindsay Corporation, Omaha, NE (US)

(21) Appl. No.: 13/663,168

(22) Filed: Oct. 29, 2012

Related U.S. Application Data
(62) Division of application No. 11/765,280, filed on Jun. 19, 2007.

(51) Int. Cl. F16B 23/00

(52) U.S. Cl. 411/403

(57) ABSTRACT

An apparatus is disclosed for connecting truss rods and other rigid braces of an irrigation system, wherein the rods include shaft sections with enlarged cylindrical heads at the ends thereof and form part of a truss-type framework supporting a conduit. A coupling assembly for holding a pair of such truss rods together in axial alignment is disclosed and includes a top plate and a bottom plate clamped together with a connecting bolt having a non-circular collar. The collar on the bolt cooperates with similarly shaped holes in the plates of the coupling assembly to prevent relative rotation between the plates and also between the bolt and the coupling assembly. The bolt includes a head with a hexagonal drive recess for use with an appropriate driving tool.

### RELATED APPLICATIONS

The present application is a divisional patent application and claims priority benefit, with regard to all common subject matter, of earlier-filed U.S. nonprovisional patent application titled “IRRIGATION MACHINE TRUSS SYSTEM CONNECTOR ASSEMBLY”, U.S. patent application Ser. No. 11/765,280, filed Jun. 19, 2007. The identified earlier-filed application is hereby incorporated by reference into the present application in its entirety.

### TECHNICAL FIELD

The present invention relates generally to agricultural irrigation systems. More particularly, the present invention concerns a coupling assembly for joining truss rods together at junctions spaced along a truss-type framework that supports a liquid-carrying conduit of the irrigation system, as well as an improved bolt-and-nut assembly.

### BACKGROUND

The water-carrying conduits of irrigation spans associated with conventional irrigation systems are typically under compressive loading between mobile towers of the system and are held in such condition by truss-type framework forming a part of each span. The framework is typically positioned underneath the conduit and maintains the same in a slightly upwardly bowed condition when empty. Conventionally, the framework is made up of elongated truss rod assemblies and additional brace components. Inasmuch as the truss rod assemblies add rigidity to the system and help maintain the conduit in compression during normal operation, such truss rod assemblies are themselves normally in tension.

A truss rod assembly traditionally includes a series of individual truss rods positioned in a generally axial alignment with one another. Each truss rod is connected to the next adjacent truss rod at a coupling, which typically also connects to additional brace components. Because of the number of such couplings along even a single span of an irrigation system, the erection of such a span is often an inefficient and time-consuming process. For example, traditional couplings are clamped together using conventional bolt and nut pairs, requiring considerable time and energy to be expended by an operator when erecting or disassembling a span in order to prevent the coupling from rotating as it is clamped around a pair of truss rods. In addition multiple tools are required to turn both the bolt and nut together to tighten or loosen the clamping assembly.

### SUMMARY

The present invention provides an apparatus to couple pairs of truss rods that provides for a more efficient erection or disassembly of irrigation spans. In one aspect of the present invention, an irrigation system is provided having a liquid conduit that spans a pair of mobile towers and is supported between the towers by framework including truss rods, each rod presenting an enlarged head and a shaft section projecting therefrom. A coupling assembly joins a pair of the truss rods in a generally axially aligned orientation with the enlarged heads thereof being adjacent one another. The coupling includes first and second plates that cooperatively present outer enlarged portions that extend about the shaft sections of truss rods and present an inside dimension smaller than the enlarged heads. The plates each include at least one opening that is located inward from the enlarged portions and receives the enlarged heads, and further include aligned connecting strips. The connecting strips on each plate have aligned bolt-receiving holes extending therethrough, wherein each bolt-receiving hole has a non-circular shape. A bolt-and-nut assembly clamps the plates to one another to securely couple the truss rods to one another. The bolt-and-nut assembly includes a connecting bolt inserted through the bolt-receiving holes of the plates, wherein the bolt includes a collar received in and axially aligned with the bolt-receiving holes of the plates. The collar presents a non-circular shape that complements that of each of the bolt-receiving holes such that the plates and the connecting bolt are restricted from rotating relative to one another about the bolt axis, thereby allowing a span to be erected or taken down much more efficiently than would be possible with prior art connectors.

Another aspect of the present invention concerns an improved bolt for use in releasably clamping together plates of a truss rod coupling in an irrigation system. The bolt includes an elongated body with a head at one end thereof and a threaded shaft projecting from an opposite end thereof, wherein the head has a centrally located non-circular drive recess. The bolt body further includes a collar located axially between the head and threaded shaft, wherein the collar has a non-circular cross-sectional shape.

Various other aspects and advantages of the present invention will be apparent from the following detailed description of the preferred embodiments and the accompanying drawing figures.

### BRIEF DESCRIPTION OF THE DRAWINGS

A preferred embodiment of the invention is described in detail below with reference to the attached drawing figures, wherein:

FIG. 1 is a fragmentary, perspective, somewhat schematic view on a reduced scale of a typical irrigation system, with which a coupling in accordance with the present invention may be employed;

FIG. 2 is an enlarged, fragmentary elevational view of one side of one of the spans of the system, with part of the bracing broken out for clarity, illustrating the manner in which a coupling in accordance with the present invention may be installed;

FIG. 3 is an enlarged, fragmentary perspective view of the truss rod coupling shown in FIG. 2 and associated structure of the irrigation span;

FIG. 4 is an enlarged, fragmentary perspective view of the truss rod coupling shown in FIG. 3 and associated structure of the irrigation span, the view similar to that of FIG. 3, but from the opposite vantage point;

FIG. 5 is a fragmentary, exploded perspective view of the truss rod coupling shown in FIG. 4, illustrating certain mounting components thereof;

FIG. 6 is an enlarged, fragmentary side sectional view of the truss rod coupling shown in FIG. 5 and associated structure of the irrigation span, the view taken along the line 6-6 of FIG. 3

FIG. 7 is an enlarged, perspective view of a connecting bolt of the fastener for clamping the two plates of the coupling together;

FIG. 8 is an enlarged, perspective view of the connecting bolt depicted in FIG. 7, the view similar to that of FIG. 7, but from the opposite vantage point;

FIG. 9 is a perspective view of the top plate component of the truss rod coupling depicted in FIGS. 2-6;

FIG. 10 is a perspective view of the top plate component, similar to that of FIG. 9, but from the opposite vantage point;

FIG. 11 is an enlarged, plan view of the top plate component, particularly illustrating in detail a pair of slots for receiving a portion of enlarged rod heads of truss rods to be coupled together;

FIG. 12 is a perspective view of the bottom plate component of the truss rod coupling depicted in FIGS. 2-6;

FIG. 13 is a perspective view of the bottom plate component, similar to that of FIG. 12, but from the opposite vantage point; and

FIG. 14 is an enlarged, plan view of the bottom plate component, particularly illustrating in detail a pair of slots for receiving a portion of enlarged rod heads of truss rods to be coupled together.

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION

The present invention is susceptible of embodiment in many different forms. While the drawings illustrate, and the specification describes, certain preferred embodiments of the invention, it is to be understood that such disclosure is by way of example only. There is no intent to limit the principles of the present invention to the particular disclosed embodiments.

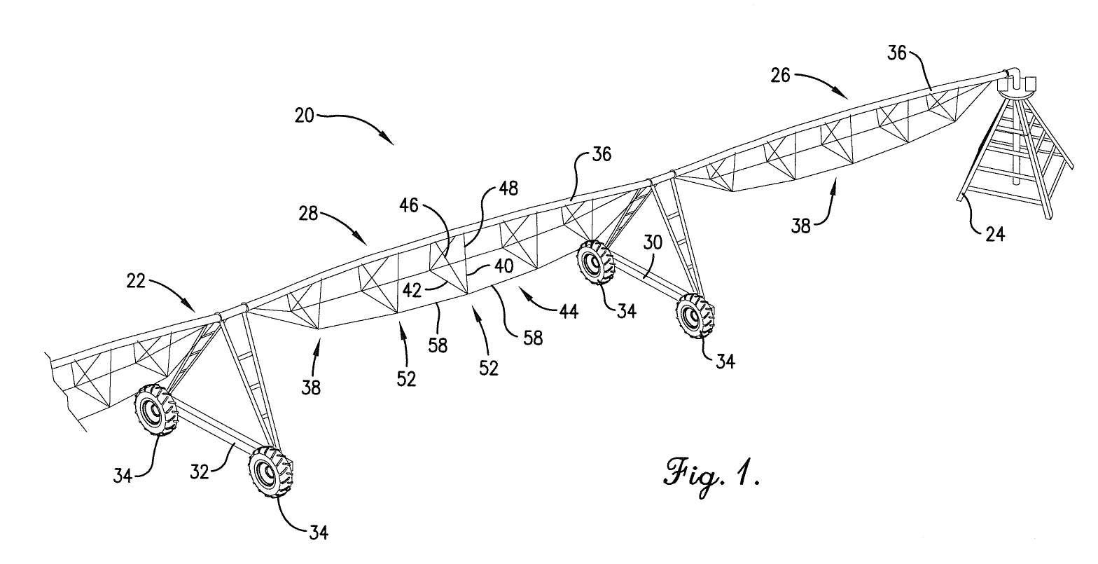

The irrigation system 20 selected for purposes of illustration in FIG. 1 comprises a center pivot system that includes a main section 22. Main section 22 is pivotally connected at its inner end to a stationary tower 24, the tower having access to a well. The main section 22 is comprised of a number of interconnected spans 26 and 28 supported by mobile towers 30 and 32. While only two spans 26 and 38 are illustrated for example purposes, it will be appreciated by those of ordinary skill in the art that an irrigation system typically includes several such spans supported by mobile towers and that the number of spans and towers shown is not intended to confine the scope of the present invention. It will be appreciated that the coupling of the present invention, as hereinafter described, may be utilized with the truss of any or all of the above-noted spans. Further, it will be recognized that the principles of the present invention are not limited to use with a center pivot system, but may also be employed with other types of irrigation systems, including, for example, lateral move systems and other types that do not employ a fixed center pivot tower.

As is well known, the wheels 34 of main towers 30 and 32 are preferably driven by suitable drive motors (not shown). Generally, steerable wheels or an outer tower (not shown) are pivoted about an upright axis by a suitable steering motor (not shown) associated with the outer tower so that the spans of the irrigation system follow a predetermined track presented by a buried cable or the like. As is also well known, the drive motors for the towers are controlled by a suitable safety system (not shown) such that they may be slowed, or completely shut down, in the event of the detection of an adverse circumstance.

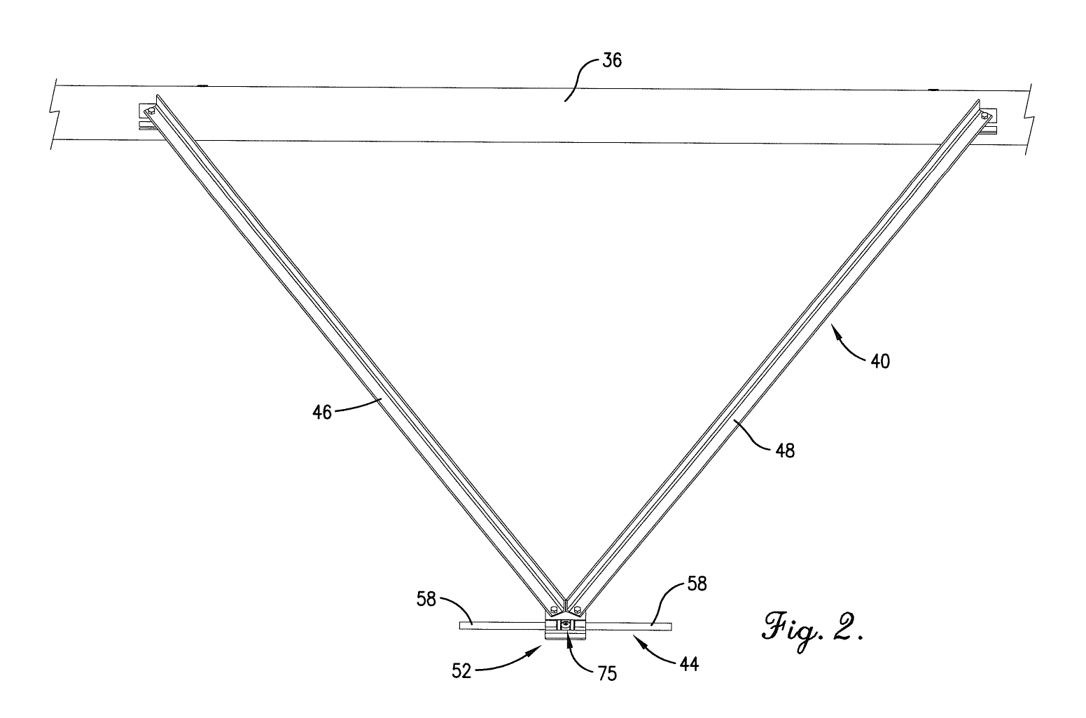

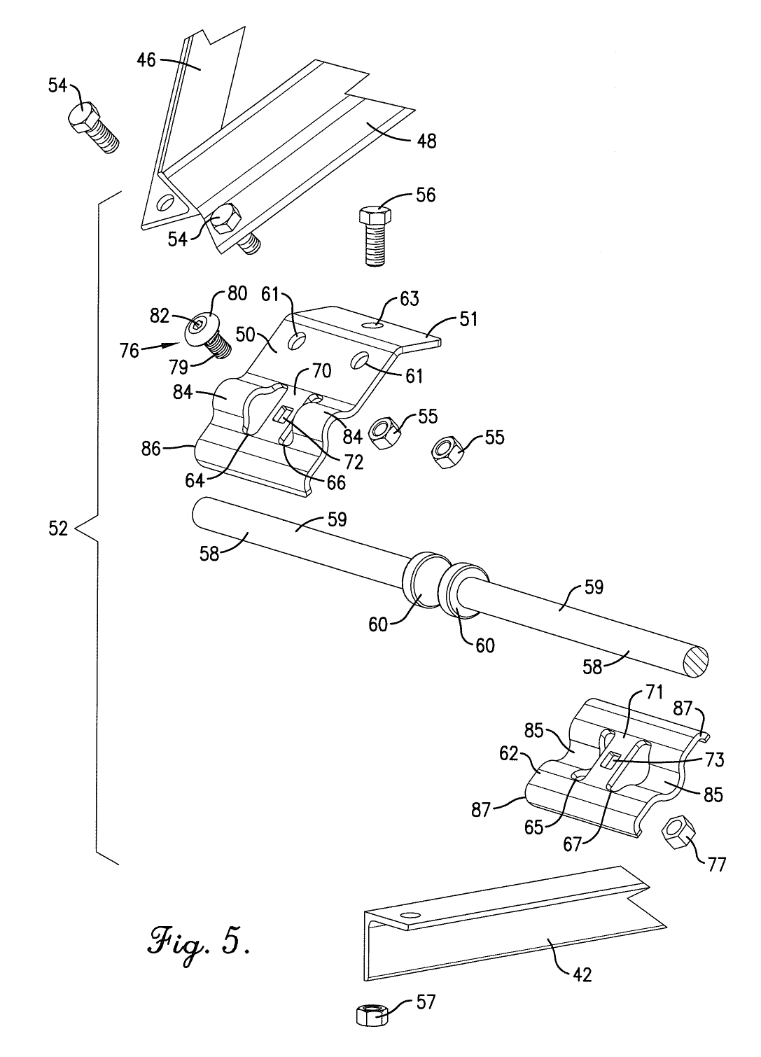

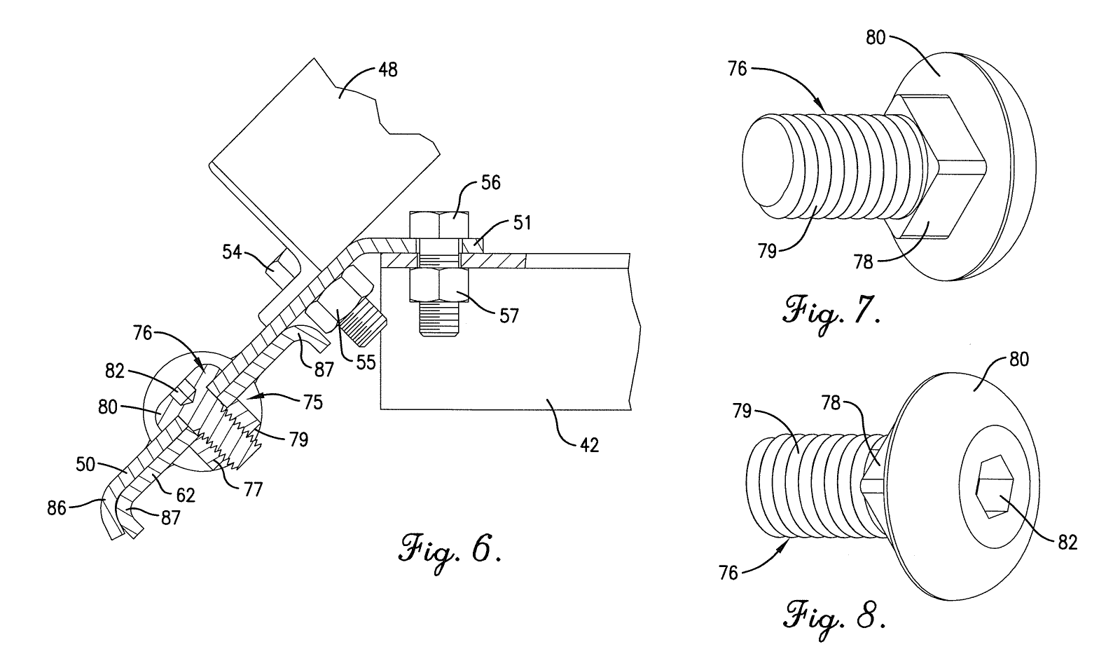

Each of the spans 26 and 28 includes a conduit 36 that is connected in fluid flow communication with all other conduits of the system to provide water along the length of the system to numerous sprinklers or other water emitting devices (not shown) in order to irrigate a field. Each conduit 36 is slightly arched or bowed when empty and is supported in such condition by a truss-type framework 38 connected to conduit 36 and disposed below the same. Among other things, each framework 38 includes a plurality of downwardly and outwardly angled V-braces 40 on one side of the conduit, as well as a horizontal, transverse brace 42 that interconnects opposing V-braces on opposite sides of conduit 36 at the apexes of the V-braces 40. In addition, framework 38 includes a pair of truss rod assemblies 44 on opposite sides of conduit 36 that interconnect successive V-braces 40 at their apexes and connect at opposite ends to terminal portions of the conduit 36. As illustrated in FIGS. 2-6, each of the V-braces 40 comprises a pair of rigid members 46 and 48 that are fixed at their upper ends to conduit 36 and converge at their lower ends to a top plate 50 of a coupling assembly 52. The lower and outer ends of members 46 and 48 are secured to top plate 50 by bolts 54 and corresponding nuts 55. In a similar fashion, transverse brace 42 is shown by example to be affixed to top plate 50 at each coupling by a bolt 56 and a corresponding nut 57.

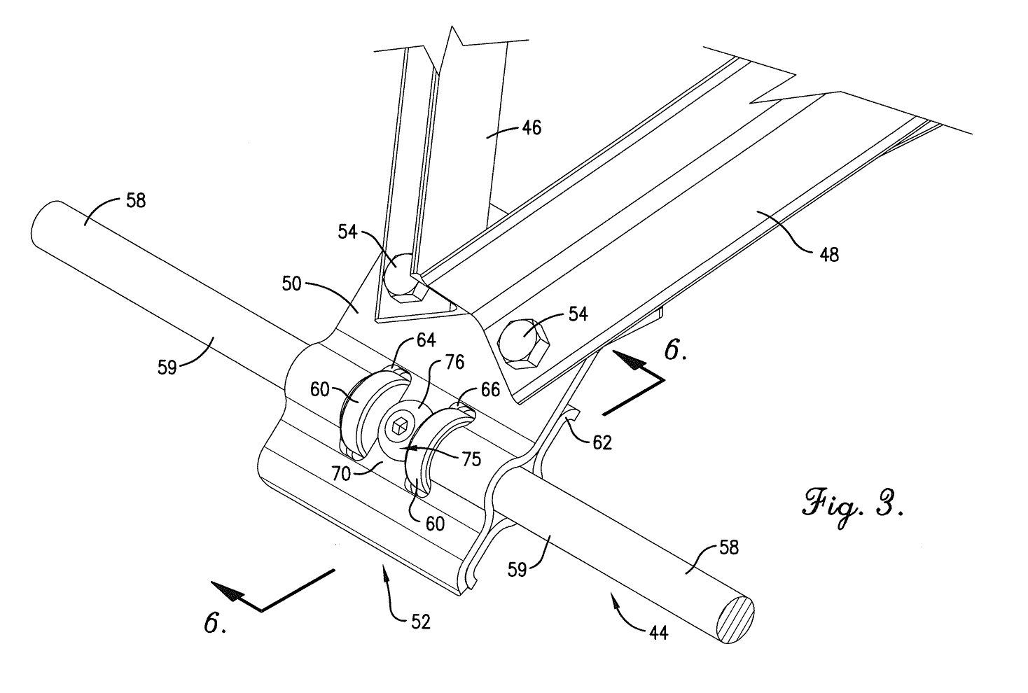

The truss rod assembly 44 on each side of framework 38 includes a series of individual truss rods 58 that are disposed in generally axial alignment with one another. Each truss rod 58 is connected to the next adjacent truss rod in the series at the apex of a V-brace 40, particularly at the coupling assembly 52. As illustrated in FIGS. 3-5, each truss rod 58 includes a shaft section 59, is provided with enlarged, cylindrical heads 60 at its opposite ends, and is connected at opposite ends to V-braces 40. The enlarged heads 60 fit into and are securely held in at least one pocket formed by clamped together plates of corresponding coupling assemblies 52. In this respect, it will be noted that the top plate 50 of coupling assembly 52 includes an enlarged outwardly humped portion 84 and is provided with a pair of side-by-side slots 64 and 66. A bottom plate 62 of coupling assembly 52 similarly includes an enlarged outwardly humped portion 85 and is provided with a pair of side-by-side slots 65 and 67. Both the top plate 50 and the bottom plate 62 will be discussed in further detail below.

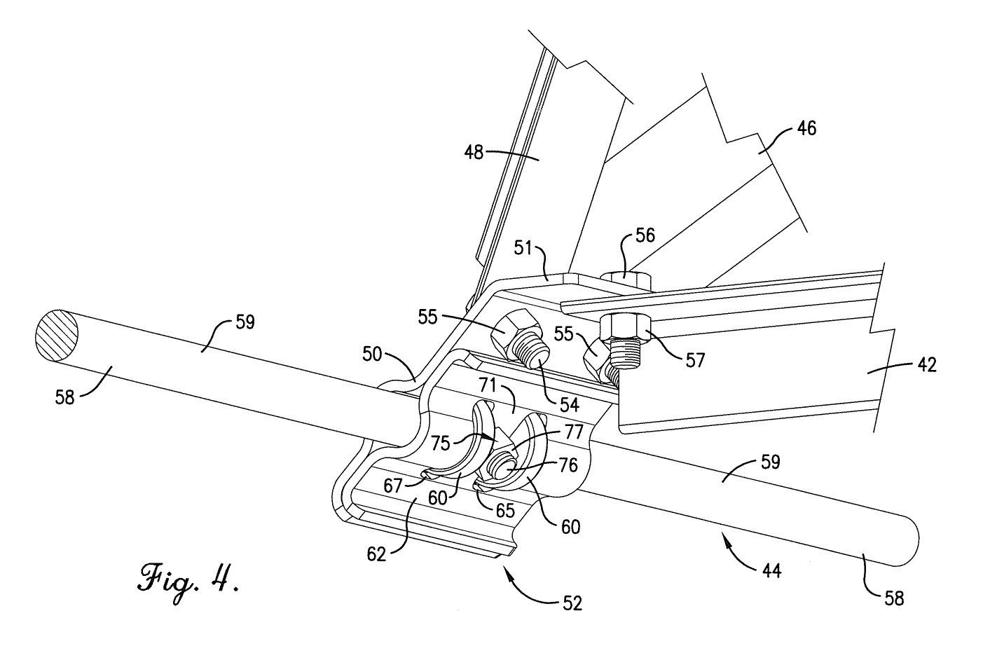

The top plate 50 and the bottom plate 62 serve to cooperate in clamping the enlarged headed ends 60 of a pair of truss rods 58 into a securely retained condition at the apex of the V-brace 40. Most preferably, the opposing heads of a pair of adjacent truss rods 58 are received within openings created by corresponding pairs of slots 64, 65 and 66, 67 of plates 50 and 62. A connecting bolt 76 passes through the top plate 50 and the bottom plate 62 to retain the coupling assembly 52 in a clamped condition (see FIGS. 3-4). However, it is noted that the enlarged heads 60 could just as easily be contained within a single slot or opening cooperatively formed by the pair of plates, or even within an outwardly humped portion of a single plate. So long as the coupling holds the enlarged heads 60 against axial movement while in tension, such variations would not depart from the teachings of the present invention.

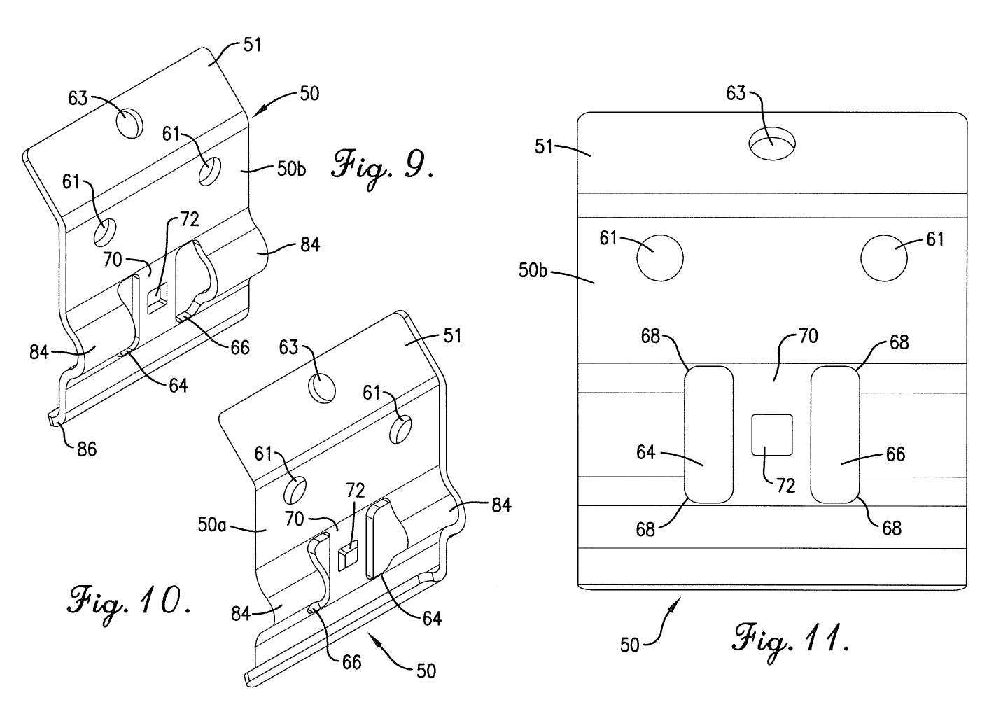

The illustrated top plate 50 includes an inside face 50a and an outside face 50b. The top plate 50 presents opposite sides, parallel to the axial alignment of the truss rods 58, that include enlarged humped portions 84. The enlarged humped portions 84 have an arcuate shape, bowed outwardly relative to the outside face 50b of the plate, as shown in FIGS. 3 and 9-10. Each enlarged outwardly humped portion 84 extends in a generally arcuate shape away from a generally planar surrounding surface of the top plate 50. As illustrated, the top plate 50 also includes a pair of side-by-side slots 64 and 66 positioned interiorly adjacent the enlarged outwardly humped portions 84. The side-by-side slots 64 and 66 have a generally rectangular shape with rounded corners when viewed from the side of either the inside face 50a or the outside face 50b of the top plate 50. Each of the slots 64 and 66 is configured to receive therein a portion of the enlarged head 60 of a truss rod 58. In the illustrated embodiment, the corners 68 of side-by-side slots 64 and 66 are raidused (see FIG. 11). The raidused corners 68, particularly the corners adjacent the enlarged outwardly humped portions 84, tend to limit any stress concentration points that could cause failure of the part as the truss rods 58 bear against the sides of the side-by-side slots 64 and 66 when the truss rod assemblies 44 are in tension. It is to be understood, of course, that the shape of the side-by-side slots 64 and 66 and the raidused corners 68 are provided by way of example only and that such slots could take the form of any shape capable of receiving therein at least a portion of the enlarged heads 60 of the truss rods 58. For example, the top plate 50 could alternatively be provided with one opening dimensioned to accommodate both enlarged heads.

As illustrated, the top plate 50 includes a pair of holes 61 for connection to the V-brace 40. Top plate 50 further includes an angled flange 51, with a hole 63, for connection to the transverse brace 42. The pair of holes 61 and the flange 51 are positioned transverse to the slots 64 and 66 and the enlarged outwardly humped portions 84. The lower and outer ends of V-brace rigid members 46 and 48 are secured to the top plate 50 by bolts 54 passing through holes in the outer ends of the rigid members 46 and 48 and through the holes 61 of the top plate 50. Corresponding nuts 55 tighten on bolts 54 to clamp the rigid members 46 and 48 to the top plate 50, as shown in FIGS. 3-4. An end of transverse brace 42 is secured to the flange 51 of the top plate 50 by a bolt 76 passing through the hole in the outer end of the brace 42 and through the hole 63 of the flange 51. A corresponding nut 77 tightens on bolt 76 to clamp the brace 42 to the flange 51 of the top plate 50, as shown in FIG. 4. It will be appreciated by one of ordinary skill in the art that connection of the V-brace 40 and the transverse brace 42 to the top plate 50 could also be accomplished by other suitable means, such as by welding, without departing from the teachings of the present invention.

The top plate 50 also includes a bend 86 on the side of the plate 50 opposite that of the flange 51. The bend 86 turns inward to present a generally right angle in cross-section relative to the inside face 50a. The bend 86 strengthens and provides rigidity to the top plate 50. It will be appreciated by one of ordinary skill in the art that such a bend could take other shapes, or not be present at all, without departing from the teachings of the present invention.

The top plate 50 further includes a connecting strip 70 located between the side-by-side slots 64 and 66 and aligned parallel to the slots 64 and 66 and the enlarged outwardly humped portions 84. The connecting strip 70 includes a non-circular hole 72 therethrough for permitting secure clamping of the top plate 50 to the bottom plate 62 using a bolt-and-nut assembly 75, the hole 72 being described in more detail below. It is noted that the illustrated connecting strip 70 positioned between the slots 64 and 66 is most preferred. However, it is possible under the principles of the present invention to provide additional strips or alternate strip location, such as transverse to the enlarged outwardly humped portions 84, so long as at least one strip on the top plate 50 and the bottom plate 62 cooperate to provide for secure clamping of the coupling assembly 52.

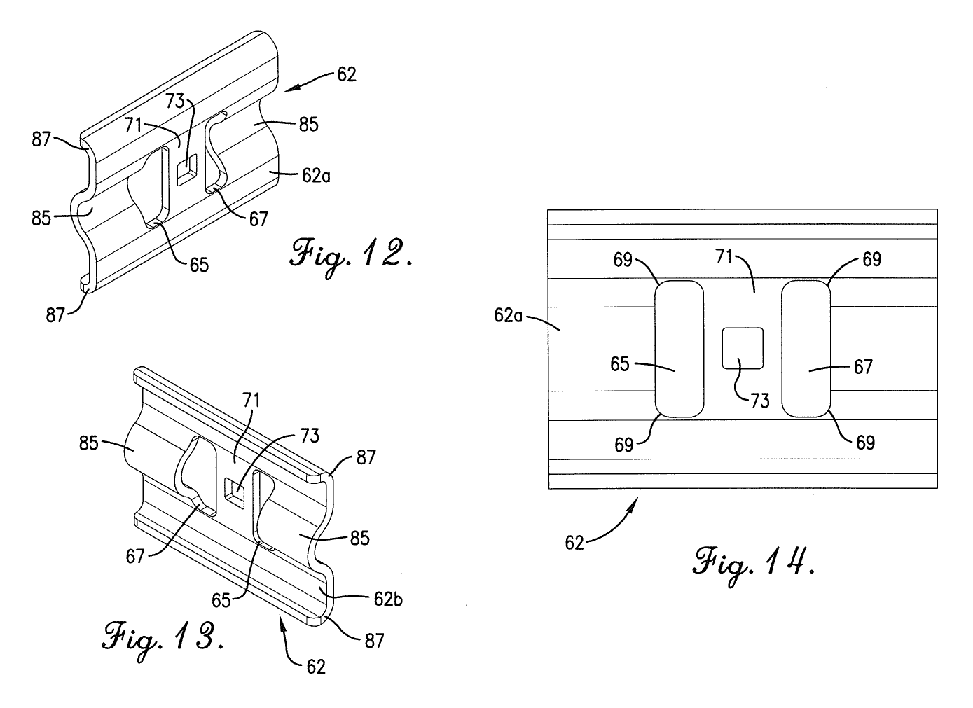

Turning to the details of the bottom plate 62, the preferred embodiment thereof includes an inside face 62a and an outside face 62b. The bottom plate 62 presents opposite sides, parallel to the axial alignment of the truss rods 58, that include enlarged humped portions 85. The enlarged humped portions 85 have an arcuate shape, bowed outwardly relative to the outside face 62b of the plate, as shown in FIGS. 4 and 12-13. Each enlarged outwardly humped portion 85 extends in a generally arcuate shape away from a generally planar surrounding surface of the bottom plate 62. As illustrated, the bottom plate 62 also includes a pair of side-by-side slots 65 and 67 positioned interiorly adjacent the enlarged outwardly humped portions 85. The side-by-side slots 65 and 67 have a generally rectangular shape with rounded corners when viewed from the side of either the inside face 62a or the outside face 62b of the bottom plate 62. Each of the slots 65 and 67 is configured to receive therein a portion of the enlarged head 60 of a truss rod 58. In the illustrated embodiment, the corners 69 of side-by-side slots 65 and 67 are raidused (see FIG. 14). The raidused corners 69, particularly the corners adjacent the enlarged outwardly humped portions 85, tend to limit any stress concentration points that could cause failure of the part as the truss rods 58 bear against the sides of the side-by-side slots 65 and 67 when the truss rod assemblies 44 are in tension, in like fashion to the corresponding slots in the top plate 50. It is again to be understood, of course, that the shape of the side-by-side slots 65 and 67 and the raidused corners 69 are provided by way of example only and that such slots could take the form of any shape capable of receiving therein at least a portion of the enlarged heads 60 of the truss rods 58. For example, the bottom plate 62 could alternatively be provided with one opening dimensioned to accommodate both enlarged heads.

The bottom plate 62 also includes a pair of bends 87 on the sides of the plate 62 positioned transverse to the slots 65 and 67 and the enlarged outwardly humped portions 85. The bends 87 turn outward to present generally right angles in cross-section relative to the outside face 62b. The bends 87 strengthen and provide rigidity to the bottom plate 62. It will be appreciated by one of ordinary skill in the art that such a bend could take other shapes, or not be present at all, without departing from the teachings of the present invention.

Similar to the top plate 50, the bottom plate 62 further includes a connecting strip 71 located between the side-by-side slots 65 and 67 and aligned parallel to the slots 65 and 67 and the enlarged outwardly humped portions 85. The connecting strip 71 includes a non-circular hole 73 therethrough for permitting secure clamping of the bottom plate 62 to the top plate 50 using a bolt-and-nut assembly 75, the hole 73 being described in more detail below. It is noted that the illustrated connecting strip 71 positioned between the slots 65 and 67 is most preferred. However, it is possible under the principles of the present invention to provide additional strips or alternate strip locations, such as transverse to the enlarged outwardly humped portions 85, so long as at least one strip on the bottom plate 62 and the top plate 50 cooperate to provide for secure clamping of the coupling assembly 52.

The holes 72 and 73 in the connecting strips 70 and 71 of the top plate 50 and the bottom plate 62 are shaped to prevent relative rotation between the top plate 50 and the bottom plate 62 when cooperating with a connecting bolt 76, the bolt 76 being described in more detail below. As illustrated particularly in FIG. 11, the hole 72 in the top plate 50 is shown to be generally square when viewed from the outside face 50b of the top plate 50. In similar fashion, as illustrated particularly in FIG. 14, the hole 73 in the bottom plate 62 is shown to be generally square when viewed from the outside face 62b of the bottom plate 62. Although in the illustrated embodiment, the holes 72 and 73 are generally square, it will be appreciated by one of ordinary skill in the art that such shape is not necessary, but rather that any non-circular shape could also be used so long as cooperation between the hole and a connecting bolt prevents relative rotation therebetween. For example, holes in the plates could be other polygonal shapes, segmented circles, or even oval, without departing from the teachings of the present invention. It is also to be understood that although the holes 72 and 73 of the top plate 50 and the bottom plate 62 are shown to be the same shape, such conformity is not required, again provided that cooperation between the holes and a collar on the connecting bolt prevents relative rotation therebetween. Additionally, while the illustrated embodiment shows one hole 72 in the top plate 50 and one hole 73 in the bottom plate 62, it is clear that more holes could also be used to clamp the two plates together to form a coupling that would remain in accordance with the present invention.

The top plate 50 and the bottom plate 62 cooperatively define a coupling assembly 52, which receives the enlarged heads 60 of truss rods 58, as shown in FIGS. 3-4. The illustrated coupling assembly 52 is formed by clamping the plates 50 and 62 together to securely couple the truss rods 58 together and prevent relative axial movement of the rods 58. The plates 50 and 62 forming the coupling assembly 52 are clamped together using a bolt-and-nut assembly 75. The connecting bolt 76 of the assembly 75 passes through the holes 72 and 73 in the plates 50 and 62. While the illustrated embodiment of coupling assembly 52 includes a top plate 50 and a bottom plate 62 (with the associated pair of holes 61 and flange 51 for connection with the V-brace 40 and the transverse brace 42, respectively), it is to be emphasized that such embodiment is by way of example only. It is clearly within the ambit of the present invention to provide an alternate embodiment (not shown) of a coupling assembly comprising two bottom plates 62 (such embodiment would, of course, not include the holes 61 and flange 51 of top plate 50). In particular regard, this alternate embodiment of the coupling assembly would provide the same advantages as the illustrated embodiment, but could be used at locations along the truss-type framework 38 where connection to V-braces or transverse braces is not necessary, such as at the junction of the truss rods 58 and the conduit 36 at the ends of each of the spans 26 and 28.

The connecting bolt 76 and associated nut 77 clamp the top plate 50 and the bottom plate 62 together to securely couple the truss rods 58 to one another. As illustrated particularly in FIGS. 7-8, the bolt 76 includes a head 80, a non-circular collar 78, and a threaded shaft portion 79. During clamping of the top plate 50 and bottom plate 62, the bolt 76 is received in and is axially aligned with the holes 72 and 73 in the plates 50 and 62. The non-circular collar 78 cooperates with the non-circular shape of the holes 72 and 73 to prevent relative rotation about the bolt axis between the bolt 76 and the plates 50 and 63. Such a configuration is effective to allow the nut 77 to be tightened onto the bolt 76 using only a single tool, as rotation of the nut 77 about the bolt 76 will not cause rotation of the bolt 76. In addition, the illustrated embodiment of the non-circular collar 78 has sufficient depth such that, when the bolt 76 is received in the holes 72 and 73, the collar 78 extends through the hole 72 in the top plate 50 and at least partly into the hole 73 in the bottom plate 62, thereby preventing relative rotation about the bolt axis between the two plates 50 and 62 of the coupling assembly 52. As will be described in more detail below, this facilitates construction of the irrigation system.

It is noted that while the illustrated embodiment depicts the non-circular collar 78 of the bolt 76 having a generally square cross-section, which matches the shape of the holes 72 and 73, the collar 78 need not be such a matching size or shape. As will be appreciated by one of ordinary skill in the art, the collar 78 could also be a smaller size, a different shape (such as other polygonal shapes, segmented circles, or even an oval), or a combination of different sizes and shapes, so long as cooperation between the collar and the holes prevents relative rotation between the bolt and at least one of the plates. As an example, it is possible under the principles of the present invention to have a square shaped hole in the plate and a cross shaped collar on the bolt, provided that the collar fits within at least one of the holes to cooperatively prevent relative rotation between the bolt and at least one of the plates. Such modifications to the illustrated embodiment of the collar 78 are well within the ambit of the present invention. It is further noted that although the illustrated embodiment shows the bolt 76 received in the plates 50 and 62, such that the head 80 of the bolt 76 is bearing against the top plate 50, it is clear that the insertion direction of the bolt 76 could be reversed such that the head 80 of the bolt 76 would bear against the bottom plate 62 without departing from the teachings of the present invention.

Turning now to the head 80 of the bolt 76, as shown particularly in FIG. 8, the head 80 includes a non-circular drive recess 82 presented therein. The non-circular drive recess 82 allows for a corresponding tool (not shown) to be used to rotate the bolt 76 relative to the nut 77 in the event that the relationship between the non-circular collar 78 and holes 72 and 73 no longer prevent relative rotation therebetween (such as if the shape of one or both of the holes 72 and 73 become “stripped” and cease to non-rotatably receive the collar 78). While the illustrated embodiment shows the drive recess 82 having a unique hexagonal cross-section (allowing cooperation with an Allen wrench, the angled shape of such tool being particularly advantageous for the often limited space between a coupling assembly 52 and other parts of the truss-type framework 38), it will be appreciated by one of ordinary skill in the art that the drive recess 82 could take on any appropriate non-circular shape such that a corresponding tool could be used to rotate the bolt 76 relative to the nut 77. For example, the drive recess in such an alternative embodiment could be square, or take on a flat head or Phillips head screw-type shape, such that an appropriate tool could be used to cooperate with such a drive recess for rotation, without departing from the teachings of the present invention.

### Operation

In brief, an individual irrigation span 28 is typically assembled “loosely” on the ground prior to erection upon towers 30 and 32. During such assembly, the conduit 36 and various components of the truss-type framework 38 are joined with fasteners to give the span 28 its shape, but such fasteners are not fully tightened until the span 28 is erected upon towers 30 and 32 (for example, nuts would be threaded on bolts and tightened to a certain degree, but not to the full extent that they will be during final erection).

In the case of the illustrated embodiment, for each coupling assembly 52, the top plate 50 and the bottom plate 62 are positioned around the enlarged heads 60 of truss rods 58 as shown, for example, in FIG. 3. A connecting bolt 76 is inserted through the holes 72 and 73 in the plates 50 and 62 and a nut 77 is received onto the threaded shaft 79 end of the bolt 76. The nut 77 is sufficiently tightened (e.g., by hand) so that the collar 78 is received in the holes 72 and 73 to thereby prevent relative rotation of the plates 50 and 62 during erection. This assists in maintaining the truss rods 58 and other framework in proper orientation during erection. V-braces 40 and transverse braces 42 are attached as described in more detail above, and such process is repeated for each coupling assembly 52 along the span 28. Once the span 28 is assembled on the ground, it is erected onto towers 30 and 32. An operator then tightens all of the fasteners of the truss-type framework 38.

As described in more detail above, because of the cooperation between the non-circular collar 78 on the bolt 76 and the non-circular holes 72 and 73 in the plates 50 and 62, the bolt 76 is non-rotatably held in place within the coupling assembly 52. Thus, the operator only needs a single tool in order to fully tighten the nut 77 on the bolt 76 to clamp the plates 50 and 62 in their fully tightened condition around the enlarged heads 60 of truss rods 58, saving both time and tool requirements. As can be seen from the illustrated spans 26 and 28 in FIG. 1, due to the large number of such coupling assemblies 52 along even a single span 28, the improvement in convenience and performance for an operator is significant.

For span disassembly operations, various benefits of the present invention are again realized. For example, to disassembly a span 28, an operator must unfasten each coupling assembly 52. During this operation as well, the non-rotative relationship between the bolt 76 and the plates 50 and 62 allows the operator to use a single tool to remove the nut 77 from the both 76 to uncouple plates 50 and 62 and thereby disassemble truss rods 58.

It is noted that during a disassembly operation, it is possible to discover that the relationship between the non-circular collar 78 and holes 72 and 73 no longer prevent relative rotation therebetween (such as if the shape of either or both of the holes 72 and 73 become “stripped” and cease to non-rotatably receive the collar 78). In such a case, the non-circular drive recess 82 allows for a corresponding tool (not shown) to be used to unscrew the bolt 76 relative to the nut 77 to provide for disassembly of the coupling assembly 52. In the illustrated embodiment, the drive recess 82 is depicted as having a unique hexagonal cross-section, allowing an Allen wrench to be used for disassembly (the angled nature of such tool being particularly advantageous for the often limited space between a coupling assembly 52 and other parts of the truss-type framework 38). As described in more detail above, however, the drive recess 82 may take on a variety of shapes provided that a corresponding tool can be used to rotate the bolt 76 relative to the nut 77.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventor hereby states her intent to rely on the Doctrine of Equivalents to determine and assess the reasonably fair scope of the present invention as pertains to any apparatus not materially departing from but outside the literal scope of the invention as set forth in the following claims.

What is claimed is:

1. A bolt for use with an irrigation machine truss system, the bolt comprising:
an elongated body including a head at one end thereof and a threaded shaft projecting from an opposite end thereof,
said head having a centrally located non-circular drive recess,
said body including a collar located axially between the head and threaded shaft,
said collar having a non-circular cross-sectional shape.

2. The bolt as claimed in claim 1,
said collar presenting a cross-sectional dimension that is less than that of the head.

3. The bolt as claimed in claim 2,
said cross-sectional dimension of the collar being greater than that of the shaft.

4. The bolt as claimed in claim 2,
said cross-sectional dimension of the collar being generally constant along the axial length thereof.

5. The bolt as claimed in claim 1,
said non-circular shape of the collar being polygonal.

6. The bolt as claimed in claim 5,
said non-circular shape of the collar being square.

7. The bolt as claimed in claim 1,
said drive recess having a polygonal shape.

8. The bolt as claimed in claim 7,
said drive recess having a hexagonal shape.

9. The bolt as claimed in claim 1,
said body being metal.

10. A bolt for use with an irrigation machine truss system, the bolt comprising:
an elongated body including a head at one end thereof and a threaded shaft projecting from an opposite end thereof,
said head including a planar top surface with a circular boundary and a dome-shaped upper surface coupled to the circular boundary,
said head further including a centrally located drive recess with a hexagonal cross-sectional shape,
said body including a collar having a square cross-sectional shape with rounded corners located axially between said head and said threaded shaft.
